(19) United States
(12) Patent Application Publication
(10) Pub. No.: US 2026/0183178 A1
(43) Pub. Date: Jul. 2, 2026

(54) SEQUENCED MASSAGE BLADDERS

(71) Applicant: LEAR CORPORATION, Southfield, MI (US)

(72) Inventors: Grzegorz Kasperczyk, Warszawa (PL); Samuel Blair, Rochester, MI (US); David J. Abdella, Farmington Hills, MI (US)

(21) Appl. No.: 19/007,830

(22) Filed: Jan. 2, 2025

(51) Int. Cl. A61H 9/00

(52) U.S. Cl. CPC A61H 9/0078; A61H 2201/0149; A61H 2201/1238; A61H 2201/50

(57) ABSTRACT

A system includes a plurality of fluid bladders that are in fluid communication with a fluid supply source, and a fluid passage that formed between at least two sheets of material. Each fluid bladder is fluidly connectable with the fluid passage in sequence, and the fluid passage defines a variable restrictive path that sequentially inflates the plurality of fluid bladders via alternating high and low pressure zones.

### BACKGROUND

Seats may include bladders that are configured in a comfort assembly installed within a seat cushion or seat back. The bladders may inflate and deflate to provide a massage effect.

### BRIEF DESCRIPTION OF THE DRAWINGS

FIG. 1 is a perspective view of an example seat.

FIG. 2A is top view of one example of a comfort assembly with a plurality of bladders in a resting state.

FIG. 2B is similar to FIG. 2A but shows a first bladder inflating.

FIG. 2C is similar to FIG. 2B but shows a second bladder inflating after the first bladder is inflating.

FIG. 2D is similar to FIG. 2C but shows a third bladder inflating after the second bladder is inflating.

FIG. 3 is a magnified view of a fluid passage comprises a restrictive flow path connectable to a series of bladders.

FIG. 4 is a schematic view of the fluid passage of FIG. 3.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates generally to a comfort assembly for a vehicle seat where fluid bladders are inflated in sequence to provide a massage effect. In some implementations, a fluid system interfaces with the comfort assembly and fluidly connects the fluid bladders to a fluid passage that is shaped to form adjacent high and low pressure areas to allow bladders to inflate sequentially.

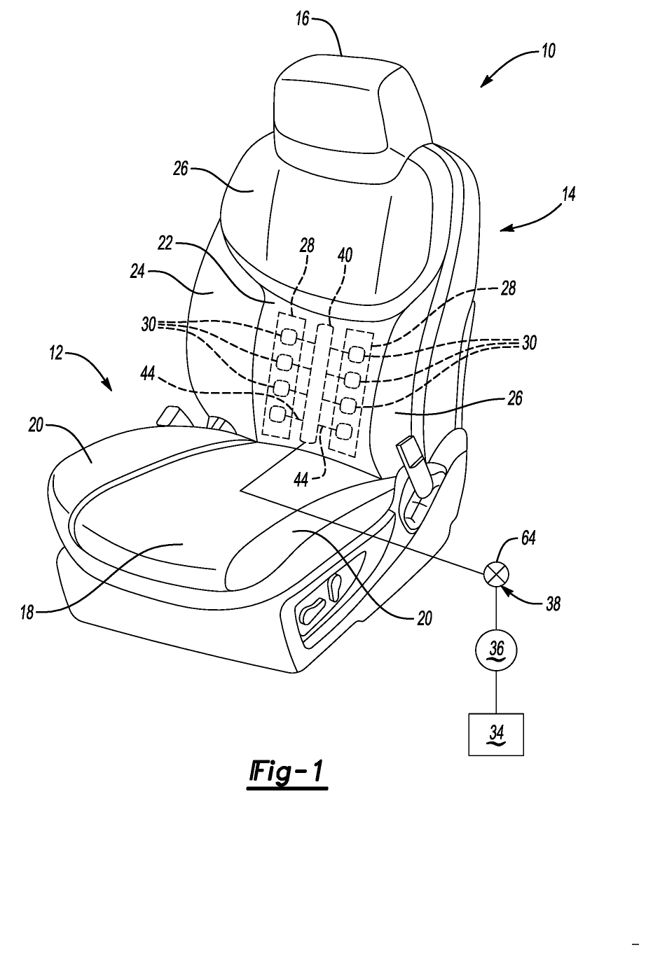

FIG. 1 illustrates a seat assembly 10 according to one example embodiment. The seat assembly 10 may be utilized as a vehicle seat assembly 10 for seating in a vehicle, such as an automobile, an aircraft, a watercraft, or any other seating environment. The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for pivotal adjustment relative to the seat bottom 12. A head restraint 16 may also be mounted to the seat back 14.

The seat bottom 12 includes a central seating surface 18 and a seating surface along a pair of side bolster regions 20 laterally spaced about the central seating surface 18. The seat back 14 includes a pelvic/lumbar seating surface 22 with a pair of laterally spaced apart side bolster regions 24 on either side. A thoracic/shoulder seating surface 26 is provided above the pelvic/lumbar seating surface 22 and the seating surface of seat back side bolster regions 24. It should be understood that this is just one example of a seat configuration, and that other configurations could also be utilized.

In some implementations, the seat assembly 10 may include one or more comfort assemblies 28 installed within the seat bottom 12 and/or the seat back 14. In one example, a comfort assembly 28 is configured to provide a massage effect with pulsing movement that is transferred through the seat bottom 12 or seat back 14 to an associated portion of a seated occupant.

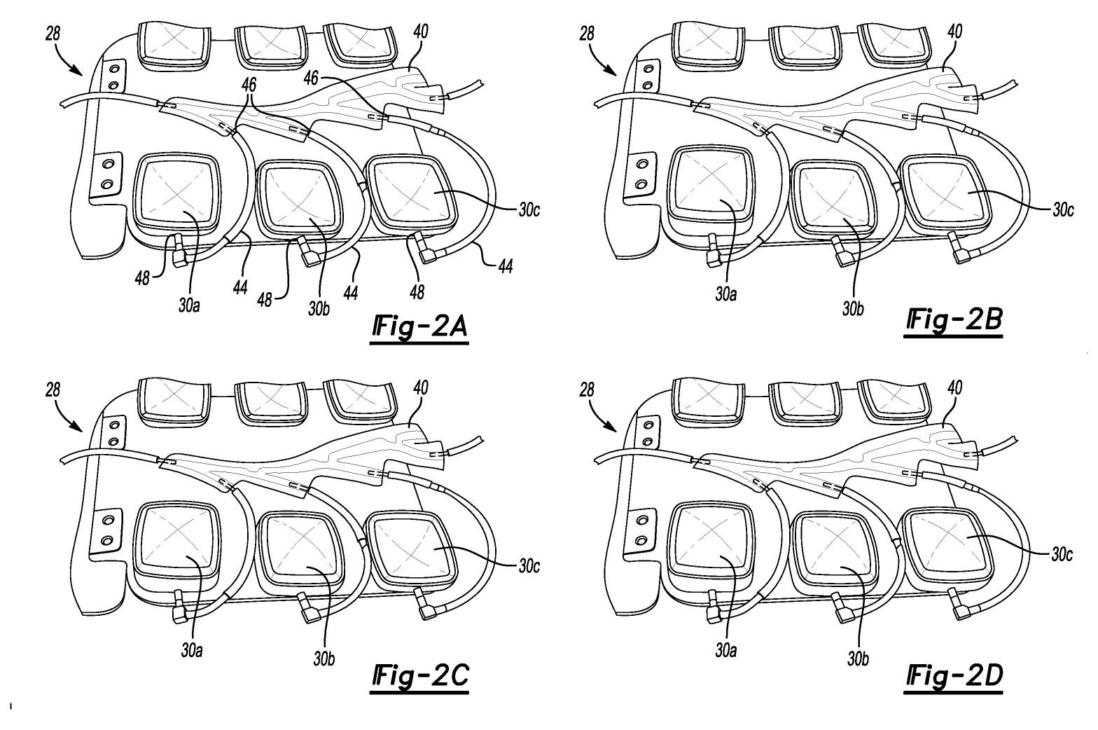

FIGS. 2A-D illustrate an example of a comfort assembly 28 that is installable within the seat assembly 10. The comfort assembly 28 includes one or more fluid bladder assemblies 30 that are selectively inflatable via an actuator assembly 32, which is schematically shown in FIG. 1. In some implementations, the fluid bladders 30 comprise discrete inflatable/deflatable pouches or cells, and the actuator assembly 32 controls inflation and/or deflation of the bladder assemblies 30 via one or more controllers 34. The actuator assembly 32 may include a fluid supply source 36 that is connected to a valve assembly 38 to provide a source of fluid to the fluid bladder assemblies 30. The fluid supply source 36 may comprise a compressor, fan, air pump, blower, pump or pneumatic pump, for example. In one example, the one or more controllers 34 regulate compressed air into and out of the bladder assemblies 30 in the seat assembly 10. The controller 34 and actuator 32 may be installed in the seat back 14, under the seat bottom 12, or anywhere suitable in the vehicle.

The one or more controllers 34 may include a processing unit and non-transitory memory for executing various control strategies. The processing unit can be a custom made or commercially available processor, a central processing unit (CPU), or generally any device for executing software instructions. The memory can include any one or combination of volatile memory elements and/or nonvolatile memory elements. The processing unit can be programmed to execute one or more programs stored in the memory. The programs may be stored in the memory as software code, for example. The programs stored in the memory may include one or more additional or separate programs, each of which includes an ordered list of executable instructions for implementing logical functions associated with controlling the valve bank. While shown as a single controller, each controller 34 may be comprised of one or more controllers. The controller 34 may also be in communication with, and responsive to instructions from, another controller. Those skilled in the art who have the benefit of this description will be able to determine how to configure the one or more controllers 34 for the sequential valve inflation purposes set forth below.

FIGS. 2A-D illustrates an example of a comfort assembly 28 that is installable within the seat assembly 10. In some implementations, the fluid bladders 30 of the comfort assembly 28 are inflated in a sequenced manner. In one example, the comfort assembly 28 includes a fluid passage or path 40 that is formed between at least two sheets of material 42, such as a plastic elastomer material, for example. In one example, the sheets of material 42 comprise flat planar portions that are formed from a thermoplastic elastomer, e.g., TPU material. In implementations, the fluid passage or path 40 is formed by a welding process.

In some implementations, each fluid bladder 30 is fluidly connectable with the fluid passage 40 in sequence via linear connections 44 one after the other (FIG. 1), and the fluid passage 40 defines a variable restrictive path that sequentially inflates the fluid bladders 30 via alternating high and low pressure zones. In one example, the variable restrictive path comprises a plurality of reduced flow portions along the flow path and is shaped such that low pressure zones become high pressure zones as bladders 30 inflate in a chain sequence.

FIG. 2A shows an example of a comfort assembly 28 with a first bladder 30a, a second bladder 30b, and a third bladder 30c in a resting state. The connections 44 between the bladders 30a-c and the fluid passage 40 comprise tubular members that connect an outlet port 46 from the fluid passage 40 to an inlet port 48 to the associated bladder 30a-c. FIG. 2B is similar to FIG. 2A but shows the first bladder 30a in an inflated position. FIG. 2C is similar to FIG. 2B but shows the second bladder 30b inflating after the first bladder 30a is inflating. FIG. 2D is similar to FIG. 2C but shows the third bladder 30c inflating after the second bladder 30b is inflating.

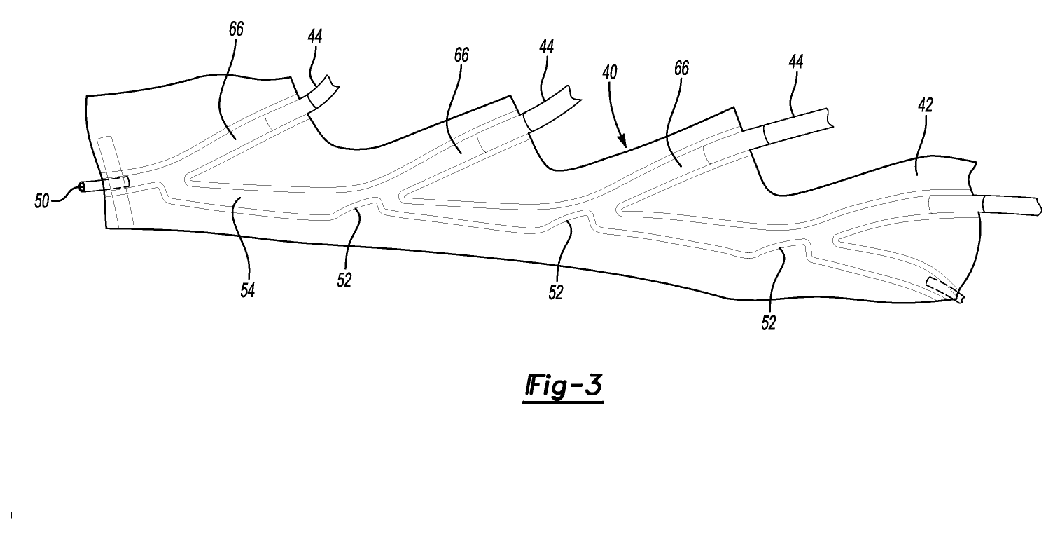

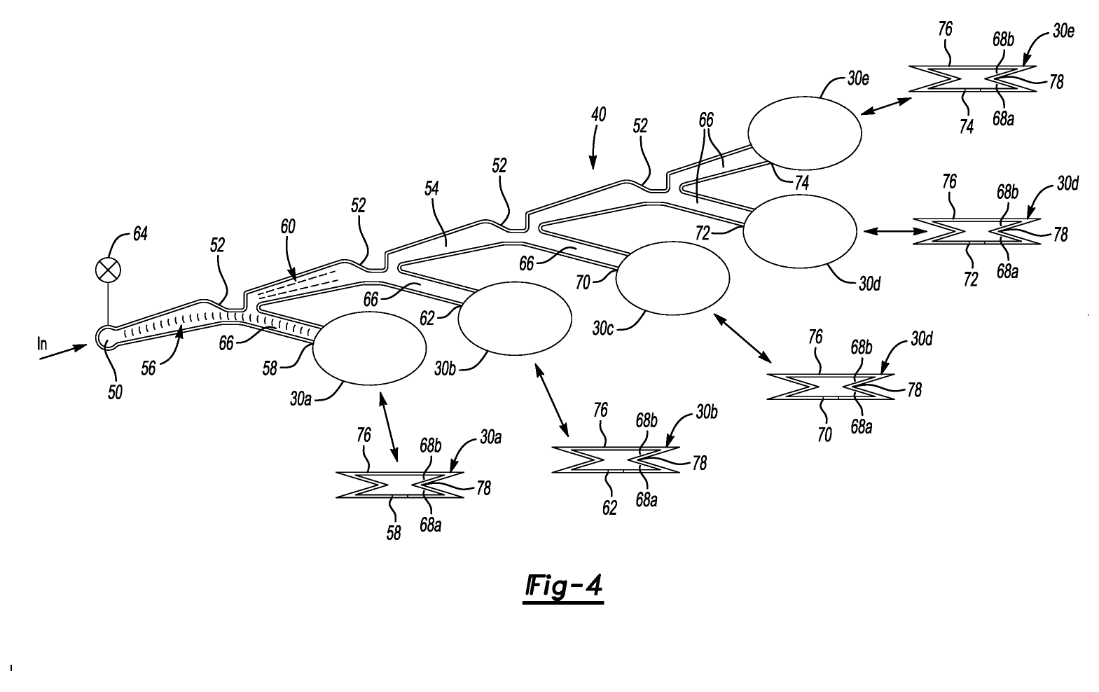

In some implementations, the fluid passage 40 comprises an inlet 50 in fluid communication with the fluid supply source 36 and has a series of restrictions 52 as shown in FIGS. 3-4. The inlet 50 may comprises a port, opening, aperture that is formed within the material used to form the passage itself. In implementations, the series of restrictions 52 comprise discrete reduced flow portions or pinched locations that are spaced apart from each other along a flow path 54.

In one example, each restriction 52 has a venturi shape, e.g., an hourglass shape; however, other restrictive shapes could also be utilized.

FIG. 4 shows a schematic representation of the flow path 54 as defined by the fluid passage 40 formed within the plastic sheets of material. In this example, the plurality of fluid bladders 30 comprises at least a first bladder 30a and a second bladder 30b and may include a third bladder 30c, fourth bladder 30d, and fifth bladder 30e. Other bladders may also be added as needed to provide a desired configuration. In implementations, during inflation of the first bladder 30a, a high pressure zone 56 is generated upstream of an inlet 58, e.g., fluid connection port, to the first bladder 30a, and a low pressure zone 60 is formed in the fluid path 54 between the first bladder 30a and the second bladder 30b. This forces/directs the fluid flow toward the inlet 58 of the first bladder 30a such that the first bladder 30a starts inflating prior to inflation of the second bladder 30b.

In some implementations, in accordance with the first bladder 30a nearing completion of inflation, and during initial inflation of the second bladder 30b, a high pressure zone is generated that is upstream of an inlet 62 to the second bladder 30b, and fluid flow to the third bladder 30c is reduced via a low pressure zone formed in the fluid path 54 between the second bladder 30b and the third bladder 30c. Thus, the high pressure zone 56 and the lower pressure zone 60 move in tandem in a downstream direction once the first bladder 30a is finished inflating such that the second bladder 30b is able to inflate prior to the third bladder 30c inflating. This sequential movement of the high and low pressure zones continues until all the bladders 30a-e have been inflated.

In some implementations, deflation of the bladders 30 may occur an a reverse manner with fluid being pumped or drawn out in sequence.

In some implementations, a single valve 64 is associated with the inlet 50 to the fluid passage 40. In other words, there is only one valve 38 that is required for inflation of all fluid bladders 30a-e associated with the fluid path 54. This significantly simplifies the overall system. In one example, the valve 38 may comprise a 2-way valve having an inlet and an outlet, and which either allows fluid to pass through the valve or stops fluid flow through the valve. Examples of such valves include ball valves, gate valves, and globe valves, which each offer different flow characteristics and shut-off capabilities. A valve other than a 2-way valve may also be used.

In some implementations, the fluid passage 40 comprises a single primary fluid path 54 where the plurality of fluid bladders 30a-e are fluidly connected to the single primary fluid path 54 via a plurality of branch paths 66 formed between the at least two sheets of material 42. In one example, the a single primary fluid path 54 comprises a larger cross-section path connected to the multiple bladders 30a-e via one branch path 66 that comprises a smaller cross-section path connected to only one bladder.

In some implementations, each bladder 30 may comprise a single chamber bladder or may comprise a multi-chamber bladder as shown in FIG. 4. In a multi-chamber configurations, each bladder 30a-e may have one or more chambers 68a, 68b inside one pouch body 76 that are fluidly connected to each other via a restriction or port 78.

In some implementations, the plurality of fluid bladders 30 comprise pairs of fluid bladders 30, wherein each pair of fluid bladders 30 has a first branch path 66 or connection 44 fluidly connected to one bladder 30 of the pair of fluid bladders and a second branch path 36 or connection 44 fluidly connected to the other bladder 30 of the pair of fluid bladders. An example of this is shown in FIG. 1. In this configuration, the bladders comprise parallel pairs that are aligned and inflate in sequence.

In one example, the first branch paths 66 or connections 44 are on an opposite side of the single primary fluid path 54 from the second branch paths 66 or connections 44.

In one example, the pairs of fluid bladders comprise at least four pairs.

In some implementations, the fluid passage 40 has a series of bladder connection ports or inlets 58, 62, 70, 72, 74 (FIG. 4), where one restriction 52 of the series of restrictions 52 is in the fluid path 54 upstream of each bladder connection port or inlet 58, 62, 70, 72, 74. In one example, the bladder connection ports or inlets 58, 62, 70, 72, 74 comprise discrete fluid openings spaced apart from each other in sequence along the path 54.

In some implementations, the combination of the variable restrictive flow path and the sequential filling of bladders via a single valve results in a combination that can be fluidly connected to more than three sets of bladders. Thus, an economical solution is provided for providing a massage effect with a large number of bladders but with only one valve.

In some implementations, a system comprises a plurality of fluid bladders in fluid communication with a fluid supply source, and a fluid passage formed between at least two sheets of material, wherein each fluid bladder is fluidly connectable with the fluid passage in sequence, and wherein the fluid passage defines a variable restrictive path that sequentially inflates the plurality of fluid bladders via alternating high and low pressure zones.

The system may include any of the additional features either alone or in any combination thereof. In one example, the fluid passage comprises an inlet in fluid communication with the fluid supply source, and wherein the fluid passage has a series of restrictions.

In one example, each restriction has a venturi shape.

In one example, the plurality of fluid bladders comprises at least a first bladder and a second bladder, and wherein, during inflation of the first bladder, a high pressure zone is generated upstream of an inlet to the first bladder and a low pressure zone is formed in the fluid passage between the first bladder and the second bladder.

In one example, the plurality of fluid bladders comprises at least a third bladder, and wherein the plurality of fluid bladders comprises at least a third bladder, and wherein in accordance with the first bladder being inflated, and during inflation of the second bladder, a high pressure zone is generated that is upstream of an inlet to the second bladder, and wherein fluid flow to the third bladder is reduced via a low pressure zone formed in the fluid passage between the second bladder and the third bladder.

In one example, a single valve is associated with the inlet to the fluid passage.

In one example, the fluid passage comprises a single primary fluid path where the plurality of fluid bladders are fluidly connected to the single primary fluid path via a plurality of branch paths formed between the at least two sheets of material.

In one example, the plurality of fluid bladders comprise pairs of fluid bladders, wherein each pair of fluid bladders has a first branch path fluidly connected to one bladder of the pair of fluid bladders and a second branch path fluidly connected to the other bladder of the pair of fluid bladders.

In one example, the first branch paths are on an opposite side of the single primary fluid path from second branch paths.

In one example, the pairs of fluid bladders comprise at least four pairs.

In one example, the fluid passage has a series of bladder connection ports, and wherein one restriction of the series of restrictions is in the fluid passage upstream of each bladder connection port.

In one example, the at least two sheets of material are comprised of a thermoplastic elastomer.

In one example, the plurality of fluid bladders and the fluid passage are incorporated into at least one seat component of a seat assembly.

In some implementations, a seat assembly comprises: a seat cushion; a seat back associated with the seat cushion; a seat comfort assembly mounted within at least one of the seat cushion and the seat back, wherein the seat comfort assembly comprises: a plurality of fluid bladders in fluid communication with a fluid supply source; and a fluid passage formed between at least two sheets of material, wherein each fluid bladder is fluidly connectable with the fluid passage in sequence, and wherein the fluid passage defines a variable restrictive path that sequentially inflates the plurality of fluid bladders via alternating high and low pressure zones; a fluid supply source in fluid communication with an inlet to the fluid passage; a single valve associated with the inlet to the fluid passage; and one or more controllers selectively controlling the single valve between an inflate condition and a deflate condition.

The seat assembly may include any of the additional features either alone or in any combination thereof. In one example, the fluid passage comprises a single primary fluid path where the plurality of fluid bladders are fluidly connected to the single primary fluid path via a plurality of branch paths formed between the at least two sheets of material.

In one example, wherein the fluid passage has a series of restrictions, and wherein each restriction is formed at a location where one branch path connects to the single primary fluid path.

In some implementations, a method comprises: forming a fluid passage between at least two sheets of material, wherein the fluid passage defines a variable restrictive path; connecting a fluid supply to an inlet to the fluid passage; connecting a plurality of fluid bladders to the fluid passage, wherein each fluid bladder is fluidly connected with the fluid passage in sequence; and sequentially inflating each fluid bladder via alternating high and low pressure zones in the fluid passage.

The method may include any of the additional features either alone or in any combination thereof. In one example, the plurality of fluid bladders comprises at least a first bladder and a second bladder, and the method includes: generating a high pressure zone upstream of an inlet to the first bladder to inflate the first bladder while forming a low pressure zone in the fluid passage between the first bladder and the second bladder to delay inflation of the second bladder.

In one example, the plurality of fluid bladders comprises at least a third bladder, and the method includes: subsequent to inflation of the first bladder, generating a high pressure zone upstream of an inlet to the second bladder to inflate the second bladder; and reducing fluid flow to the third bladder via a low pressure zone formed between the second bladder and the third bladder.

In one example, the method includes providing a single valve at the inlet to the fluid passage.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system comprising:
a plurality of fluid bladders in fluid communication with a fluid supply source; and
a fluid passage formed between at least two sheets of material, wherein each fluid bladder is fluidly connectable with the fluid passage in sequence, and wherein the fluid passage defines a variable restrictive path that sequentially inflates the plurality of fluid bladders via alternating high and low pressure zones.

2. The system of claim 1, wherein the fluid passage comprises an inlet in fluid communication with the fluid supply source, and wherein the fluid passage has a series of restrictions.

3. The system of claim 2, wherein each restriction has a venturi shape.

4. The system of claim 2, wherein the plurality of fluid bladders comprises at least a first bladder and a second bladder, and wherein, during inflation of the first bladder, a high pressure zone is generated upstream of an inlet to the first bladder and a low pressure zone is formed in the fluid passage between the first bladder and the second bladder.

5. The system of claim 4, wherein the plurality of fluid bladders comprises at least a third bladder, and wherein the plurality of fluid bladders comprises at least a third bladder, and wherein in accordance with the first bladder being inflated, and during inflation of the second bladder, a high pressure zone is generated that is upstream of an inlet to the second bladder, and wherein fluid flow to the third bladder is reduced via a low pressure zone formed in the fluid passage between the second bladder and the third bladder.

6. The system of claim 2, including a single valve associated with the inlet to the fluid passage.

7. The system of claim 6, wherein the fluid passage comprises a single primary fluid path where the plurality of fluid bladders are fluidly connected to the single primary fluid path via a plurality of branch paths formed between the at least two sheets of material.

8. The system of claim 7, wherein the plurality of fluid bladders comprise pairs of fluid bladders, wherein each pair of fluid bladders has a first branch path fluidly connected to one bladder of the pair of fluid bladders and a second branch path fluidly connected to the other bladder of the pair of fluid bladders.

9. The system of claim 7, wherein first branch paths are on an opposite side of the single primary fluid path from second branch paths.

10. The system of claim 8, wherein the pairs of fluid bladders comprise at least four pairs.

11. The system of claim 2, wherein the fluid passage has a series of bladder connection ports, and wherein one restriction of the series of restrictions is in the fluid passage upstream of each bladder connection port.

12. The system of claim 1, wherein the at least two sheets of material are comprised of a thermoplastic elastomer.

13. The system of claim 1, wherein the plurality of fluid bladders and the fluid passage are incorporated into at least one seat component of a seat assembly.

14. A seat assembly comprising:
a seat cushion;
a seat back associated with the seat cushion;
a seat comfort assembly mounted within at least one of the seat cushion and the seat back, wherein the seat comfort assembly comprises:
a plurality of fluid bladders in fluid communication with a fluid supply source; and
a fluid passage formed between at least two sheets of material, wherein each fluid bladder is fluidly connectable with the fluid passage in sequence, and wherein the fluid passage defines a variable restrictive path that sequentially inflates the plurality of fluid bladders via alternating high and low pressure zones;
a fluid supply source in fluid communication with an inlet to the fluid passage;
a single valve associated with the inlet to the fluid passage; and
one or more controllers selectively controlling the single valve between an inflate condition and a deflate condition.

15. The seat assembly of claim 14, wherein the fluid passage comprises a single primary fluid path where the plurality of fluid bladders are fluidly connected to the single primary fluid path via a plurality of branch paths formed between the at least two sheets of material.

16. The seat assembly of claim 15, wherein the fluid passage has a series of restrictions, and wherein each restriction is formed at a location where one branch path connects to the single primary fluid path.

17. A method comprising:
forming a fluid passage between at least two sheets of material, wherein the fluid passage defines a variable restrictive path;
connecting a fluid supply to an inlet to the fluid passage;
connecting a plurality of fluid bladders to the fluid passage, wherein each fluid bladder is fluidly connected with the fluid passage in sequence; and
sequentially inflating each fluid bladder via alternating high and low pressure zones in the fluid passage.

18. The method of claim 17, wherein the plurality of fluid bladders comprises at least a first bladder and a second bladder, and including:
generating a high pressure zone upstream of an inlet to the first bladder to inflate the first bladder while forming a low pressure zone in the fluid passage between the first bladder and the second bladder to delay inflation of the second bladder.

19. The method of claim 18, wherein the plurality of fluid bladders comprises at least a third bladder, and including:
subsequent to inflation of the first bladder, generating a high pressure zone upstream of an inlet to the second bladder to inflate the second bladder; and
reducing fluid flow to the third bladder via a low pressure zone formed between the second bladder and the third bladder.

20. The method of claim 17, including providing a single valve at the inlet to the fluid passage.
